(19) United States
(12) Patent Application Publication
(10) Pub. No.: US 2022/0095700 A1
(43) Pub. Date: Mar. 31, 2022

(54) Apparatus and Method for Transferring Pods of a Consumable Unit for an Inhalation Device from a Storage Tray to a Machine Cassette of a Consumable Unit Manufacturing Device

(71) Applicant: British American Tobacco (Investments) Limited, London (GB)

(72) Inventor: Andrew Jonathan BRAY, London (GB)

(21) Appl. No.: 17/426,139

(22) PCT Filed: Jan. 21, 2020
(86) PCT No.: PCT/GB2020/050122

§ 371 Date: Jul. 28, 2021

(30) Foreign Application Priority Data
Jan. 29, 2019 (GB) 1901208.7

(51) Int. Cl. A24F 40/70; B65B 35/46

(52) U.S. Cl. CPC A24F 40/70; B65G 2201/0226; B65B 35/46

(57) ABSTRACT

Apparatus for transferring pods, each of which form part of a consumable unit for use with an inhalation device, from a storage tray in which each pod is supported in a pod receiving pocket, to corresponding pod receiving pockets of a machine cassette forming part of a consumable unit manufacturing device, is disclosed. The apparatus comprises a transfer station to receive the tray and a machine cassette placed over the storage tray and the pods received in the storage tray. The transfer station is configured to rotate the combined tray and machine cassette so that the pods in the pod receiving pockets in the tray are transferred into corresponding pod receiving pockets in the machine cassette. A method for transferring pods the pod receiving pockets in the tray to corresponding pod receiving pockets in the machine cassette is also disclosed.

### FIELD

The present invention relates to an apparatus and a method for transferring pods, each of which form part of a consumable unit for use with an inhalation device, from a storage tray to a machine cassette of a consumable unit manufacturing device. In particular, the invention relates to an apparatus and a method for transferring pods, each of which are supported in a pod receiving pocket in the storage tray, to corresponding pod receiving pockets in a machine cassette. Once transferred, the machine cassette, together with the pods received therein, can be inserted into a consumable unit manufacturing device for carrying out one or more manufacturing steps on the pods. The invention also relates to an apparatus for transferring pods from a machine cassette back to a storage tray, and to a method of transferring pods from a storage tray to a machine cassette.

### BACKGROUND

There exists a need to provide an apparatus and a method for the efficient manufacture of consumable units for inhalation devices which may involve providing a dose of aerosolisable material to a pod of the consumable unit; positioning a closure over an end of the pod; and securing the closure to the pod. These, and other manufacturing steps, may need to be carried out on a plurality of pods in quick succession.

The pods are supplied on a storage tray. The storage tray has pod receiving pockets each of which support an individual pod so that each tray supports a plurality of pods in a structured array. In order to perform various manufacturing steps on the pods, it is necessary to transfer them from the storage trays to a machine cassette. A machine cassette also has pod receiving pockets that correspond to the pod receiving pockets of 3o the storage tray. The machine cassette is configured for insertion into a manufacturing machine to enable one or more of the manufacturing steps to be carried out on the pods whilst they are held in the machine cassette.

Once one or more manufacturing steps have been completed on the pods supported on the machine cassette, they may be transferred from the machine cassette back onto a storage tray.

### SUMMARY

In accordance with embodiments of the invention, there is provided apparatus for transferring pods, each of which form part of a consumable unit for use with an inhalation device, from a storage tray in which each pod is supported in a pod receiving pocket, to corresponding pod receiving pockets of a machine cassette forming part of a consumable unit manufacturing device, the apparatus comprising:

a transfer station to receive the tray and a machine cassette placed over the storage tray and the pods received in the storage tray, the transfer station being configured to rotate the combined tray and machine cassette so that the pods in said is pod receiving pockets in the tray are transferred into corresponding pod receiving pockets in the machine cassette.

The apparatus of the invention may comprise a receiving station adjacent to the transfer station. The receiving station may be configured to receive a tray of pods such that, when a machine cassette has been placed on the tray over the pods, the tray is insertable, together with the pods and the machine cassette, from the receiving station into the transfer station.

The tray may be slideable, together with the pods and the machine cassette placed on the tray over the pods, directly from the receiving station into the transfer station.

In certain embodiments, the transfer station comprises a cradle to receive the tray and the machine cassette placed on the tray over the pods.

The cradle may be mounted for rotation about an axis. In particular, the cradle may be configured to rotate about said axis from a first position in which the tray with a machine cassette placed on it is insertable into the cradle, into a second position in which the combined tray and machine cassette inserted into the cradle are inverted.

The cradle may also be configured to rotate in the opposite direction about said axis, from said second position into the first position.

Preferably, the cradle is configured to rotate through an angle of 180 degrees between said first and second positions.

The cradle may comprise first and second support plates configured so that a storage tray of pods, with the machine cassette placed on the storage tray, is insertable into said transfer station between said first and second support plates when said cradle is in said first position.

The first and second support plates may be spaced such that, when the cradle is rotated about said axis, a tray of pods together with the machine cassette placed upon it, is supported by the first and second support plates to prevent separation of the tray and the machine cassette.

The cradle may be configured so that the tray of pods, together with the machine cassette placed over it, extends across the axis of rotation of the cradle when the tray of pods with the machine cassette placed over it is inserted into the cradle between the support plates.

The apparatus may comprise a drive member for rotating the cradle about said axis.

The drive member can be manually operable. In certain embodiments, the drive member may be a rotatable hand-wheel. In an alternative embodiment, the drive member may comprise a motor.

The apparatus may comprise an enclosure surrounding the cradle. The enclosure may be a cylindrical drum.

The drum may have a longitudinal axis and it can be configured to rotate together with the cradle about said longitudinal axis.

Preferably, the apparatus comprises a first stationary buffer and a stop element rotatable together with the enclosure. The stop element may be configured so that it contacts the first stationary buffer to prevent the cradle rotating beyond said first position.

The apparatus may additionally comprise a second stationary buffer. The second stationary buffer may be configured such that the stop element rotatable together with the enclosure contacts the second stationary buffer to prevent the cradle rotating beyond said second position.

The apparatus may comprise a slot in the enclosure to enable a tray with a machine cassette placed on it to be inserted into the transfer station through the slot.

In accordance with another embodiment of the invention, there is provided apparatus for transferring pods, each of which form part of a consumable unit for use with an inhalation device, from a machine cassette forming part of a consumable unit manufacturing device in which each pod is supported in a pod receiving pocket, to corresponding pod receiving pockets of a storage tray, the apparatus comprising:
a transfer station to receive the machine cassette and a storage tray placed over the machine cassette and the pods received in the machine cassette, the transfer station being configured to rotate the combined machine cassette and storage tray so that the pods in said pod receiving pockets in the machine cassette are transferred into corresponding pod receiving pockets in the storage tray.

In accordance with yet another embodiment of the invention, there is provided a method for transferring pods, each of which form part of a consumable unit for use with an inhalation device, from a storage tray in which each pod is supported in a pod receiving pocket, to corresponding pod receiving pockets of a machine cassette forming part of a consumable unit manufacturing device, comprising:
placing a machine cassette over a tray of pods,
inserting the machine cassette and the tray of pods into a transfer station, and
operating the transfer station to rotate the combined tray and machine cassette so that the pods in said pod receiving pockets in the tray transfer to corresponding pod receiving pockets in the machine cassette.

### BRIEF DESCRIPTION OF THE DRAWINGS

Embodiments of the invention will be described, by way of example only, with reference to the accompanying drawings, in which:

FIG. 1 shows a perspective view of apparatus for transferring pods from a storage tray to a machine cassette of a consumable unit manufacturing device;

FIG. 2A shows a top plan view of part of the apparatus shown in FIG. 1, and in which a storage tray of pods has been placed on the receiving station part of the apparatus;

FIG. 2B shows the top plan view of FIG. 2A, in which two machine cassettes have been placed on the receiving station over the storage tray and the pods supported on the storage tray;

FIG. 2C shows a top plan view of the apparatus of FIG. 1 with the combined storage tray and machine cassettes partially inserted into the transfer station;

FIG. 2D shows the same view as FIG. 2C, but after the combined storage tray and machine cassettes have been fully inserted into the transfer station, and the transfer station has been operated to invert the combined storage tray and machine cassettes;

FIG. 3 shows a cross section through a pod and part of a machine cassette following transfer of the pod from a storage tray into the machine cassette;

FIG. 4 shows a perspective view of the pod shown in FIG. 3;

FIG. 5 shows a schematic drawing of the pod of FIG. 4 being provided with a particulate material and a closure;

FIG. 6 shows a dosing station to receive a machine cassette into which pods have been transferred and which fills the pods with particulate material; and

FIG. 7 shows a part of the dosing station of FIG. 6, with a machine cassette supported on the machine drawer.

### DETAILED DESCRIPTION

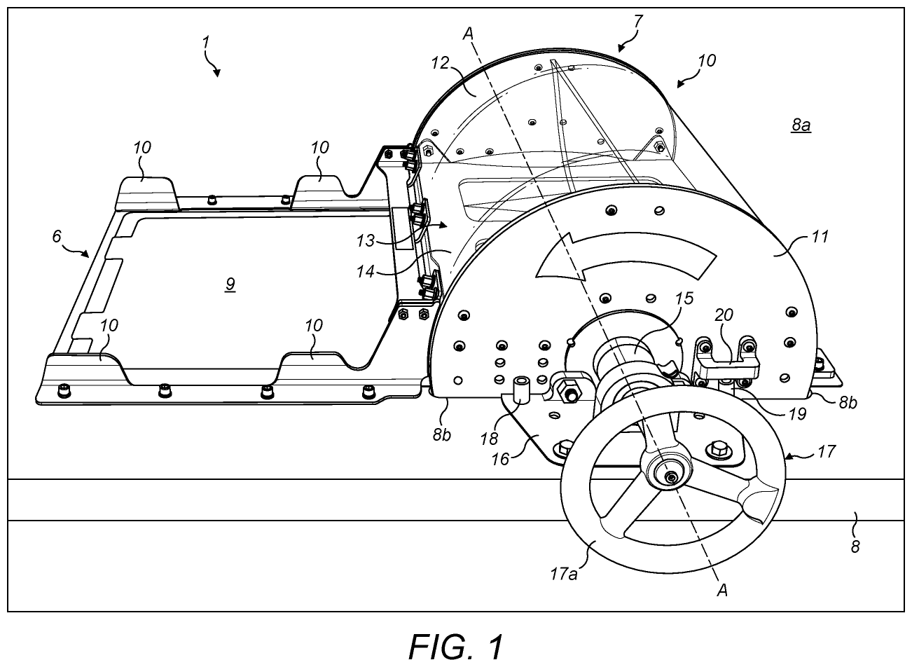

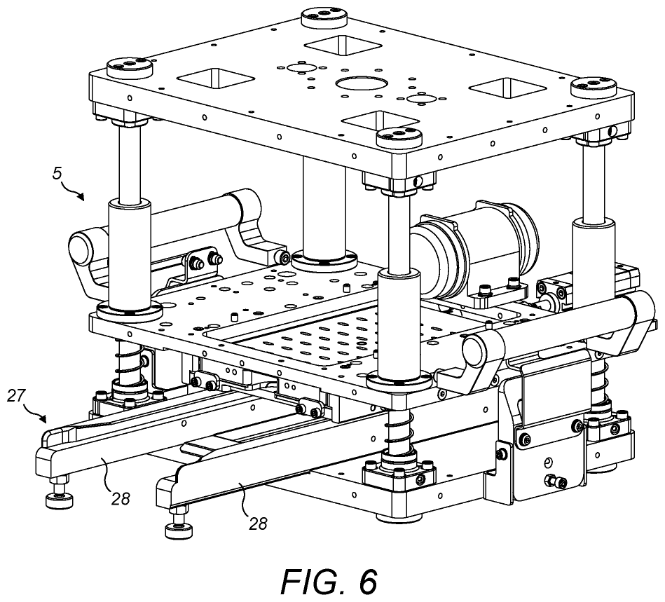

With reference to FIG. 1, there is a shown an apparatus 1 for transferring a plurality of pods 2, each of which form part of a consumable unit for use with an inhalation device, from a storage tray 3 in which each pod 2 is supported in a pod receiving pocket 3a, to corresponding pod receiving pockets 4a of a machine cassette 4 forming part of a consumable unit manufacturing device 5 (see FIG. 6). The apparatus 1, according to an embodiment of the invention, may also be used for transferring the pods 2, on which a manufacturing operation has been performed, from the machine cassette 4 back into a storage tray 3.

The pods 2 are placed in storage trays 3 following or during their manufacture at another location. The storage trays 3 are suitable for protecting and transporting the pods 2. However, in order to carry out a manufacturing operation on the pods 2, such as filling the pods 2 with a particulate material such as tobacco, they need to be transferred to a machine cassette 4 which is designed and configured to accurately hold and position the pods 2 within a consumable unit manufacturing device 5 during the manufacturing steps.

According to an embodiment of the invention, the apparatus 1 comprises a receiving station 6 and a transfer station 7, which may be mounted to the upper surface 8a of a table 8 or other support structure or frame. The table 8 has an aperture 8b and the transfer station 7 is mounted to the table 8 so that a portion of it extends into the aperture 8b below the upper surface 8a. The receiving station 6 is mounted to the upper surface 8a adjacent to the aperture 8b.

The receiving station 6 comprises a flat surface 9 with upstanding guide walls 10 along opposite edges that extend away from the transfer station 7. The flat surface 9 is a surface onto which one or more storage trays 3 of pods 2 may be placed and readied prior to moving them into the transfer station 7. The transfer station 7 comprises an is enclosure 10 in the form of a generally cylindrical drum having circular end walls 11 and a curved intermediate wall 12 extending between the end walls 11. The drum 10 is mounted to the table 8 such that its longitudinal axis is parallel to, and spaced just above its upper surface 8a, and so that a portion of the drum 10 extends through the aperture 8b in the table 8. At least a part of the curved intermediate wall 12 extending between the circular end walls 11 may be transparent.

Received within the drum 10 is a cradle 13 which comprises a pair of spaced parallel support plates 14. The cradle 13 is mounted for rotation together with the drum 10 about the longitudinal axis A-A of the drum 10, although the drum 10 could be fixed, in which case the cradle 13 would rotate within, and relative to, the drum 10. As will be explained in more detail below, the cradle 13 is configured to receive and support a storage tray 3 that supports an array of individually spaced pods 2, each pod being loosely received and supported in a pocket 2a in the storage tray 3, together with a machine cassette 4 placed on the tray 3 over the pods 2. The support plates 14 support the storage tray 3 and the machine cassette 4 placed upon it when the transfer station 7 is operated to invert the combined tray 3 and machine cassette 4 so that the pods 2 in said pod receiving pockets 3a in the tray 3 are transferred into corresponding pod receiving pockets 4a in the machine cassette 4.

An axle extends along the longitudinal axis A-A of the drum 10 through a bearing hub 15 at each end of the drum 10. The axle is attached to the drum 10, and to the cradle 13, so that the drum 10 and cradle 13 rotate in response to rotation of the axle 14 about longitudinal axis A-A. Each bearing hub 15 is immovably mounted to the table 8 via a mounting member 16.

One end of the axle 14 extends beyond the edge of the upper surface 8a of the table 8 and a drive member 17 is attached to a free end of the axle 14 to facilitate rotation of the axle by a user. As shown in FIG. 1, the drive member 17 is a manually rotatable hand wheel 17a. However, it will be appreciated that any other type of drive for rotating the drum 10 and the cradle 13 may be used, including an electric drive motor.

The mounting member 16 closest to the drive member 17a that rotatably mounts the axle and secures the drum 10 to the table 8, is provided with first and second buffers 18, 19. A stop element 20 is attached to the end wall 11 adjacent to the mounting member 16 so that one side of the stop element 20 contacts the first buffer 18 to prevent further rotation of the drum 10 when the drum 10 is in a first position, and the other side of the stop element 20 contacts the second buffer 19 when the drum 10 has been rotated into a second position. The angle of rotation between the first and second positions may be in the order of 180 degrees.

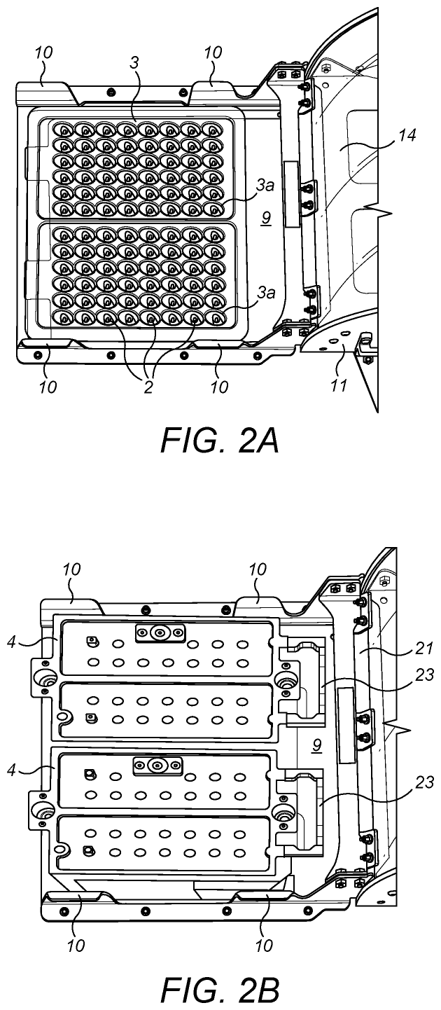

Operation of the apparatus 1 of the embodiment of the invention will now be described in more detail with reference to FIGS. 2A to 2E.

FIG. 2A shows a top plan view of the receiving station 6 of the apparatus 1. A storage tray 3 of pods 2 has been placed on the flat surface 9 of the receiving station 6, between the guide walls 10.

In FIG. 2A, two storage trays 3 are shown placed on the flat surface 9 of the receiving station 6 in side-by-side relation, between the guide walls 10. However, it will be appreciated that the apparatus 1 may be configured to receive one or more trays 3.

With reference to FIG. 2B, a machine cassette 4 has been placed over each storage tray 3. The machine cassettes 4 and the trays 3 are configured so that a machine cassette 4 locates on the tray 3 with each individual pocket 4a in the machine cassette 4 located over a corresponding individual pocket 3a containing a pod 2 in the storage tray 3. The machine cassette 4 has a top and a bottom surface. When the machine cassette 4 is inserted into the consumable unit manufacturing device 5, it is is inserted with its top surface uppermost. However, it will be understood that, as shown in FIG. 2B, the machine cassettes 4 are placed over the trays 3 in an upside down orientation, i.e. with their top surfaces facing the storage trays 3 and the pods 2 supported within the storage trays 3.

Once a machine cassette 4 has been correctly located over each tray 3, the combined storage tray 3, pods 2 and the machine cassette 4 are inserted together as a single unit into the transfer station 7. As shown in FIG. 2C, the combined tray 3, pods 2 and the machine cassette 4 are slid directly from the flat surface 9 of the receiving station 6 into the transfer station 7 in the direction of arrow A.

In an alternate embodiment, the receiving station 6 may be omitted. In this case, the machine cassette 4 may be placed over the tray 3 at another remote location before being inserted directly into the transfer station 7.

To facilitate the insertion of the combined storage tray 3, pods 2 and machine cassette 4 into the transfer station 7, the curved intermediate wall 12 of the drum 10 is provided with a slot 21 extending in an axial direction between the end walls 12. The slot 21 is aligned with the flat surface 9 of the receiving station 6 when the drum 10 is in its first position, i.e. when the stop element 20 is against the first buffer 18.

When the drum 10 is in its first position, the cradle 13 located within the drum 10 is positioned so that the combined storage tray 3, pods 2 and machine cassette 4 are pushed through the slot 21 into the cradle 13. More specifically, the combined storage tray 3, pods 2 and machine cassette 4 are pushed into the space between the spaced, parallel support plates 14 of the cradle 13. The support plates 14 are parallel and spaced from each other by a distance which is only marginally greater than the total height of a combined tray 3 containing the pods 2 with a machine cassette 4 placed upon it so that the combined storage tray 3, pods 2 and machine cassette 4 are held between the 3o support plates 14 without separating when the transfer station 7 is operated to invert the combined storage tray 3, pods 2 and machine cassette 4.

Next, as shown in FIG. 2D, the drive member 17 is rotated to rotate the drum 10 together with the cradle 13 and the combined storage tray 3, pods 2 and machine cassette 4, out of its first position and into its second position, in which the stop member 20 now contacts the second buffer 19. As a result of rotation from the first into the second position, the storage tray 3, pods 2 and the machine cassette 4 are inverted.

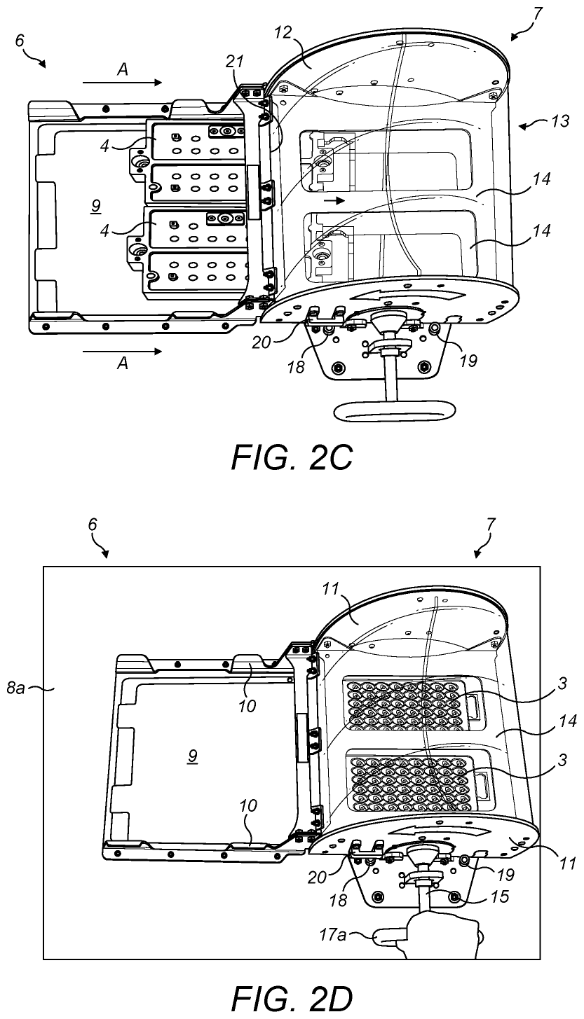

As the pods 2 are supported in the pockets 3a in the storage tray 3 under their own weight, inversion of the storage tray 3 results in each pod 2 transferring to a corresponding pocket 4a in the machine cassette 4 so that the pods 2 are now supported, the other way up, in the machine cassette 4. FIG. 3 shows a cross section through a portion of a machine cassette 4 having a support pocket 4a and a pod 2 received in the pocket 4a following transfer from a storage tray 3 using the apparatus 1 according to an embodiment of the invention. Inversion of the storage tray 3 may occur when the combined storage tray 3, pods 2, and machine cassette 4 are turned over, i.e. rotated through an angle of 180 degrees. However, rotation through less than 180 degrees may be sufficient for the weight of the pods 2 to be transferred from the storage tray 3 to the machine cassette 4.

It will be understood that, when a machine cassette 4 is placed over a tray 3, the pods 2 supported in the pod receiving pockets 3a of the storage tray 3 may each extend from a pocket into a pocket of the machine cassette 4, i.e. a part of each pod may be received in a pocket 3a in the storage tray 3 and, at the same time, another part of the pod 2 may be received in a corresponding pocket 4a in the machine cassette 4. This means that, when the combined storage tray 3, pods 2 and machine cassette 4 are inverted, there is little or no movement of the pods 2 and their weight is simply transferred from the storage tray 3 to the machine cassette 4. However, it is also possible for a pod 2 to move, i.e. drop out of a pocket 3a in which it is supported on the storage tray 3, and into a corresponding pocket 4a in the machine cassette 4, when the combined storage tray 3, pods 2 and machine cassette 4 are inverted using the apparatus 1.

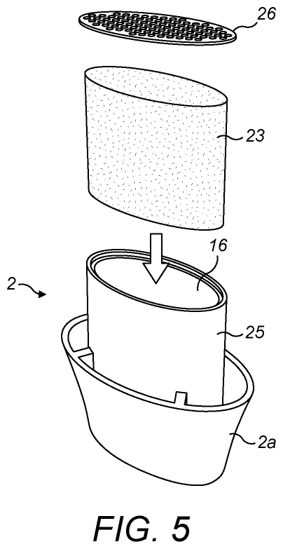

When the pods 2 are in the machine cassette 4, they are held in an upright orientation, with their open ends 22 directed vertically upwards so that they can be provided with 3o particulate material and a closure 26 (see FIG. 5) can be positioned on, and secured to, the pods 2. FIG. 3 shows how one supporting pocket 4a is shaped to receive and support a pod 2. In particular, each supporting pocket 4a is shaped to receive and support a mouthpiece portion 2a of a pod 2 so that the open end 22 of the pod 2 is directed upwards.

Optionally, the machine cassette 4 may include one or more handles 23 for manual lifting and moving of the machine cassette 4.

Once the storage tray 3, pods 2 and machine cassette 4 have been inverted using the transfer station 7 of the apparatus 1, the combined storage tray 3, pods 2 and machine cassette 4 may be slid back out of the transfer station 7 onto the flat surface 9 of the receiving station 6. As the weight of the pods 2 is no longer supported by the storage tray 3, the storage tray 3 may be lifted away to leave the machine cassette 4 with the pods 2 supported therein. The machine cassette 4 together with the pods 2 may now be removed from the receiving station 6 and inserted into the consumable unit manufacturing device 5 so that a manufacturing operation may subsequently be performed on each of the pods 2 supported by the machine cassette 4.

It will be appreciated that, once the manufacturing operation or operations have been completed, the pods 2 may also be transferred from the machine cassette 4 back onto the storage trays 3 using the same apparatus 1, should this be required.

The pods 2 may form part of a consumable unit of an inhalation device which is of a size and shape suitable to be held by an adult consumer. The consumable unit may comprise a removable atomizer cartridge which has an atomizer for atomizing a consumable liquid held in the cartridge, and a charge 23 of particulate aerosolisable tobacco. A charge of tobacco 23 may be received in a pod 2 having a mouthpiece portion 2a, to which a closure 26 for retaining the charge of tobacco 23 within the pod 2 is attached, as demonstrated by FIG. 5.

The user is able to change the atomizer cartridge and the charge of tobacco 23 when they need replacement, i.e. when the consumable liquid runs out, or when the charge of tobacco is exhausted.

3o In use, an operating unit delivers energy to the atomizer cartridge under the control of the consumer as the consumer draws air through the inhalation device. The liquid in the atomizer cartridge is atomized to form an aerosol and the particulate tobacco material is volatilized, releasing volatile flavours. The air inhaled from the inhalation device therefore delivers an aerosol of atomised liquid from the atomizer cartridge to the consumer together with the vapour generated by heating the particulate tobacco material.

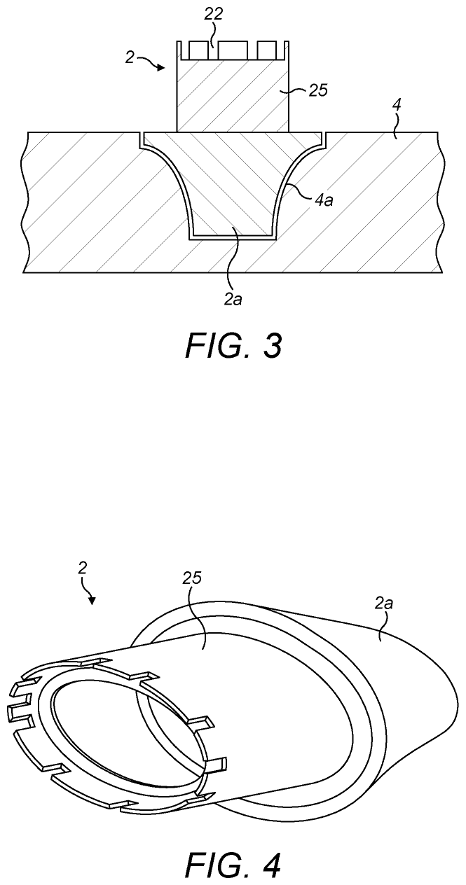

In addition to a mouthpiece portion 2a, the pod 2 of FIGS. 3 to 5 comprises an axially-extending open-ended section 25. In this example, the open-ended section 25 has an elliptical radial cross-section. The mouthpiece portion 2a is connected to the open-ended section 25 by ultrasonic welding, induction welding or any other suitable method. Alternatively, the mouthpiece portion 2a may be integrally formed with the open-ended section 25, for example by injection moulding.

The closure 26 may be in the form of a perforated screen. The closure 26 is composed for example of a mesh or foil or a moulding of plastics material. Perforations in the closure 26 allow vapour to pass in the axial direction downstream through the pod 2 towards the mouthpiece portion 2a.

The manufacturing steps carried out on pods 2 whilst they are supported in a machine is cassette 4 may include providing the pod 2 with a dose of particulate material through the open ended section 25, positioning a closure 26 over the open-ended section 25 of the pod 2, and securing the closure 26 to the pod 2.

The manufacturing steps may be carried out on a number of empty pods 2 using the manufacturing device 5 shown in FIG. 6, or a series of devices 5 similar to that shown in FIG. 6. For example, one device 5 may be a dosing station, a second device 5 may be a closure positioning station, and a third device 5 may be a closure securing station. The machine cassette 4 supporting a plurality of pods 2 is inserted into each device 5 in turn so that a charge of tobacco 23 may be dosed into the pod 2, a closure 26 may be positioned on the open-ended section 25 of the pod 2, and the closure 26 may be secured to the pod 2.

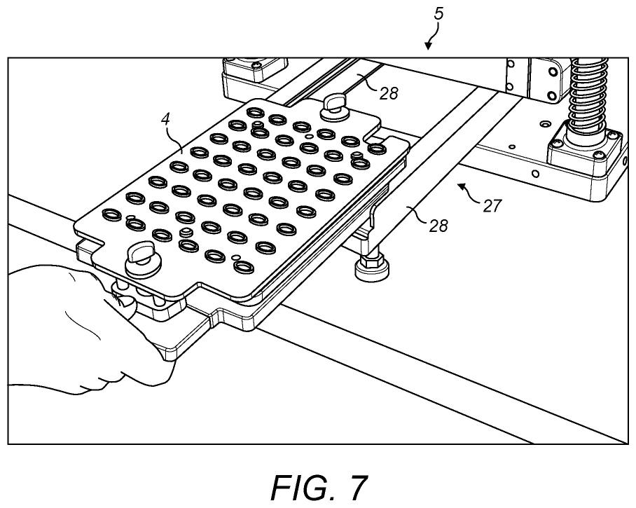

The manufacturing device 5 of FIG. 6 may comprise, for example, a machine cassette support 27 that comprises rails 28 to support the machine cassette 4 supporting a 3o plurality of pods 2. The machine cassette 4 can be inserted into the dosing station by sliding the machine cassette 4 onto the rails 28, which support opposing sides of the machine cassette 4. The machine cassette support 27 may also include a stop against which the machine cassette 4 abuts when inserted into the machine cassette support 27. The machine cassette support 27 ensures that the machine cassette 4, and the pods 2, are accurately and reliably positioned and supported within the manufacturing device 5. FIG. 7 shows a part of the dosing station of FIG. 6, with a machine cassette 4 supported on the rails 28 of the machine cassette support 27.

The machine cassette 4 provided with a plurality of empty pods 2 is moved through the apparatus of FIG. 6 so that the pods 2 are provided with a dose of particulate material and the closures 26 are positioned and secured while the pods 2 are held in the machine cassette 4.

As used herein, reference to a charge of tobacco refers to a material that includes tobacco, tobacco derivatives, expanded tobacco, reconstituted tobacco, or tobacco substitutes. The particulate material may also include a non-tobacco material. In some examples, the charge is a charge of particulate material that is powder-like, and in alternative examples may be formed by cutting of shredding a material into smaller particles. In some examples, the charge of tobacco may include a so-called ‘cut rag’, which is formed by shredding or cutting tobacco into small particles. The charge of tobacco may be produced by extruding a tobacco slurry and cutting the extruded material into particles.

It will be appreciated that the pods 2 described above may be used in devices other than a inhalation device as described. For example, the device may releases compounds from the charge of tobacco without burning, such as tobacco heating products. The inhalation device may be a heating device which releases compounds by heating, but not burning, a substrate material, for example the charge of tobacco.

In order to address various issues and advance the art, the entirety of this disclosure shows by way of illustration various embodiments in which the claimed invention(s) may be practiced and provide for superior method and apparatus for transferring pods, each of which form part of a consumable unit for use with an inhalation device, from a storage tray in which each pod is supported in a pod receiving pocket, to corresponding pod receiving pockets of a machine cassette forming part of a consumable unit manufacturing device. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. Apparatus for transferring pods, each of which form part of a consumable unit for use with an inhalation device, from a storage tray in which each pod is supported in a pod receiving pocket, to corresponding pod receiving pockets of a machine cassette forming part of a consumable unit manufacturing device, the apparatus comprising:
a transfer station to receive the tray and a machine cassette placed over the storage tray and the pods received in the storage tray, the transfer station being configured to rotate the combined tray and machine cassette so that the pods in said pod receiving pockets in the tray are transferred into corresponding pod receiving pockets in the machine cassette.

2. Apparatus according to claim 1, comprising a receiving station adjacent to the transfer station, the receiving station being configured to receive a tray of pods such that, when a machine cassette has been placed on the tray over the pods, the tray is insertable, together with the pods and the machine cassette, from the receiving station into the transfer station.

3. Apparatus according to claim 2, wherein the tray is slideable, together with the pods and the machine cassette placed on the tray over the pods, from the receiving station into the transfer station.

4. Apparatus according to any preceding claim 1, wherein the transfer station comprises a cradle to receive the tray and the machine cassette placed on the tray over the pods.

5. Apparatus according to claim 4, wherein said cradle is mounted for rotation about an axis.

6. Apparatus according to claim 5, wherein the cradle is configured to rotate about said axis from a first position in which the tray with a machine cassette placed on it is insertable into the cradle, into a second position in which the combined tray and machine cassette inserted into the cradle are inverted.

7. Apparatus according to claim 6, wherein the cradle is also configured to rotate, in the opposite direction, about said axis from said second position into the first position.

8. Apparatus according to claim 6, wherein the cradle is configured to rotate through an angle of 180 degrees between said first and second positions.

9. Apparatus according to claim 6, wherein the cradle comprises first and second support plates configured so that a storage tray of pods, with the machine cassette placed on the storage tray, is insertable into said transfer station between said first and second support plates when said cradle is in said first position.

10. Apparatus according to claim 9, wherein the first and second support plates are spaced such that, when the cradle is rotated about said axis, a tray of pods together with the machine cassette placed upon it, is supported by the first and second support plates to prevent separation of the tray and the machine cassette.

11. Apparatus according to claim 6, wherein the cradle is configured so that the tray of pods, together with the machine cassette placed over it, extends across the axis of rotation of the cradle when the tray of pods with the machine cassette placed over it is inserted into the cradle between the support plates.

12. Apparatus according to claim 5, comprising a drive member for rotating the cradle about said axis.

13. Apparatus according to claim 12, wherein the drive member is manually operable.

14. Apparatus according to claim 13, wherein the drive member is rotatable hand-wheel.

15. Apparatus according to claim 12, wherein the drive member comprises a motor.

16. Apparatus according to claim 5, comprising an enclosure surrounding the cradle.

17. Apparatus according to claim 16, wherein the enclosure is in the form of a cylindrical drum.

18. Apparatus according to claim 17, wherein the drum has a longitudinal axis and is configured to rotate together with the cradle about said longitudinal axis.

19. Apparatus according to claim 16, comprising a first stationary buffer and a stop element rotatable together with the enclosure that contacts the first stationary buffer to prevent the cradle rotating beyond said first position.

20. Apparatus according to claim 16, comprising a second stationary buffer configured such that the stop element rotatable together with the enclosure contacts the second stationary buffer to prevent the cradle rotating beyond said second position.

21. Apparatus according to claim 16, comprising a slot in the enclosure to enable a tray with a machine cassette placed on it to be inserted into the transfer station through the slot.

22. Apparatus for transferring pods, each of which form part of a consumable unit for use with an inhalation device, from a machine cassette forming part of a consumable unit manufacturing device in which each pod is supported in a pod receiving pocket, to corresponding pod receiving pockets of a storage tray, the apparatus comprising:
a transfer station to receive the machine cassette and a storage tray placed over the machine cassette and the pods received in the machine cassette, the transfer station being configured to rotate the combined machine cassette and storage tray so that the pods in said pod receiving pockets in the machine cassette are transferred into corresponding pod receiving pockets in the storage tray.

23. A method for transferring pods, each of which form part of a consumable unit for use with an inhalation device, from a storage tray in which each pod is supported in a pod receiving pocket, to corresponding pod receiving pockets of a machine cassette forming part of a consumable unit manufacturing device, comprising:
placing a machine cassette over a tray of pods,
inserting the machine cassette and the tray of pods into a transfer station, and
operating the transfer station to rotate the combined tray and machine cassette so that the pods in said pod receiving pockets in the tray transfer to corresponding pod receiving pockets in the machine cassette.
